(19) United States
(12) Patent Application Publication
(10) Pub. No.: US 2012/0054298 A1
(43) Pub. Date: Mar. 1, 2012

(54) Dynamic access control of Ethernet service flow in customer VLAN

(75) Inventors: Prashant Pandey, Bangalore (IN); Abhishek Sinha, Woodland Hills, CA (US)

(73) Assignees: Alcatel-Lucent India Limited; Alcatel-Lucent USA Inc.

(21) Appl. No.: 12/805,981

(22) Filed: Aug. 27, 2010

(51) Int. Cl. G06F 15/16

(52) U.S. Cl. 709/217

(57) ABSTRACT

Provided is a method and device for dynamic access of a service. The method includes receiving a message including a lease time associated with the service from a user device. Receiving the service from a provider and transmitting the service to the user device based on the lease time.

### BACKGROUND OF THE INVENTION

Embodiments relate to a dynamic access control mechanism for services that flow from a service provider network to a customer.

For example, in the virtual local area network (VLAN) stacking context, once the configuration is done on provider edge bridge, there is no dynamic access control mechanism for services that flow from a service provider network to a customer VLAN. This may lead to unwanted service flows in the customer VLAN at certain periods of time in hour/day/month. The unwanted service flows may unnecessarily consume the available bandwidth in the customer VLAN.

### SUMMARY OF THE INVENTION

A solution to prevent the unwanted service flows may be to build a new feature “Dynamic Ethernet Service Access Control” on existing Ethernet service infrastructures. For example, this feature may include a mechanism (e.g., a protocol message) using the Customer device/VLAN connected to the User Network Interface (UNI) port. The mechanism may send a time duration/period for which the user wants the service to be available. Once the time duration information is available on the provider bridge for the respective UNI port, the provider bridge may have the intelligence to dynamically control (start/stop) the flow of service to the customer device/VLAN based on the duration specified.

One embodiment includes a method for dynamic access of a service. The method includes receiving a message including a lease time associated with the service from a user device. Receiving the service from a provider and transmitting the service to the user device based on the lease time.

The method may further include determining a lease start time and a lease stop time based on the lease time and storing the lease start time and the lease stop time, wherein the transmitting the service is based on the lease start time and the lease stop time.

A network device includes a service lease handling module to receive a message including data associated with a service lease time from a user device. The service lease handling module receives a service from a service provider and transmits the service to the user based on the data associated with the service lease time.

The network device may further include a database configured to store the data associated with the service lease time and/or a timer module configured to determine when the service is to be transmitted to the user device based on the stored data associated with the service lease time.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 illustrates a network including a provider edge bridge according to example embodiments.

FIG. 2 further illustrates the provider edge bridge of FIG. 1 according to example embodiments.

FIG. 3 illustrates a method for dynamic access of a service according to example embodiments.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF THE EMBODIMENTS

While example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

As used herein, the term “user” may be considered synonymous to, and may hereafter be occasionally referred to, as a mobile, mobile unit, mobile station, mobile user, user equipment, subscriber, user, remote station, access terminal, client, receiver, etc., and may describe a remote user of a wired or wireless resources in a communication network. The term “user” may also be a representative of a user, for example, an administrator (network or otherwise) or some other entity acting in place of a user for some period or event. The representative of a user may also represent a group of users, for example, an administrator may be a local area network (LAN) administrator acting on behalf of all users of the LAN.

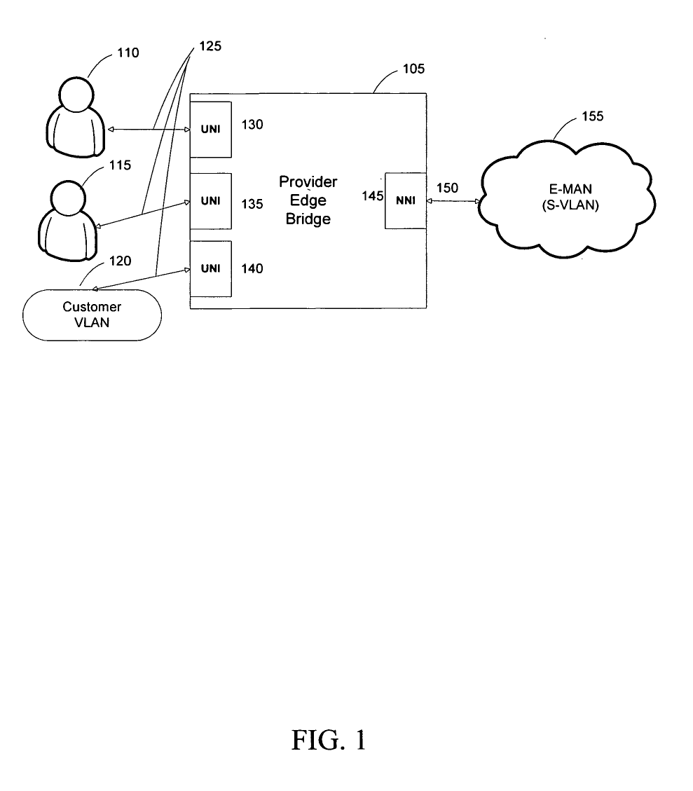

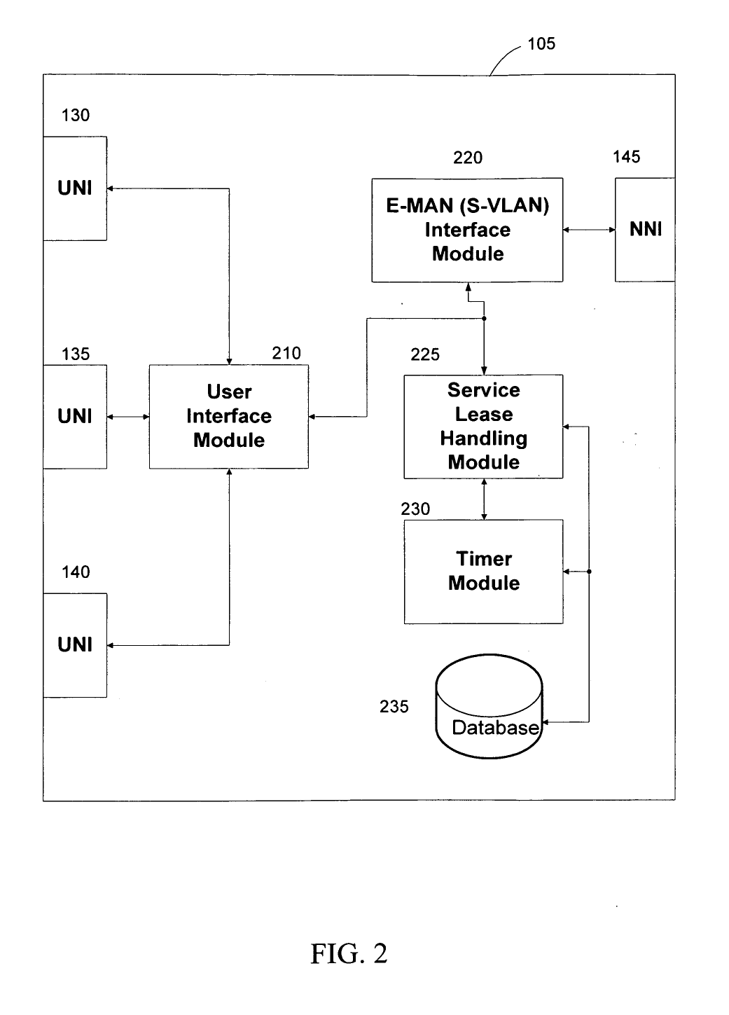

FIG. 1 illustrates a network including a provider edge bridge according to example embodiments. As shown in FIG. 1 a Provider Edge Bridge 105 (described in more detail with regard to FIG. 2 below) may interconnect a plurality of users (e.g., users 110, 115 and Customer VLAN 120) with a Metropolitan Area Network 155 (e.g., an enterprise metropolitan area network (E-MAN) or an stacked virtual local area network (S-VLAN)). The Provider Edge Bridge 105 may include a plurality of User Network Interfaces (UNI) 130, 135, 140 configured to transmit and receive communications (e.g., data packets, services, messages and/or signals) from the plurality of users 110, 115, 120. A user may be an individual user on a dedicated line (e.g. user 110 and user 115) and/or a plurality of interconnected users (e.g., Customer VLAN 120). Provider Edge Bridge 105 may also be known as a metro edge switch or some other bridging or switching device as is known by those skilled in the art.

The plurality of users 110, 115, 120 may communicate via communication channels 125. Communication channels 125 may be wired or wireless. The Provider Edge Bridge 105 may include one or more Network Node Interfaces (NNI) 145 configured to transmit and receive communications (e.g., data packets, services, messages and/or signals) from one or more networks (e.g., Metropolitan Area Network 155). Although a single NNI 145 is shown and a single Metropolitan Area Network 155 is shown, example embodiments are not limited thereto. Communication between the Provider Edge Bridge 105 and Metropolitan Area Network 155 may be via communication channels 150. Communication channels 150 may be wired or wireless.

FIG. 2 further illustrates the Provider Edge Bridge 105 of FIG. 1 according to example embodiments. As shown in FIG. 2, the Provider Edge Bridge 105 may include a plurality of interface modules. For example, the Provider Edge Bridge 105 may include a user interface module 210, and an E-MAN (S-VLAN) interface module 220. Although FIG. 2 only shows the described interface modules 210, 220, example embodiments are not limited thereto.

According to example embodiments, Provider Edge Bridge 105 may also include a service lease handling module 225, a timer module 230 and a database 235. The service lease handling module 225, a timer module 230 and a database 235 may be interconnected with each of the interface modules 210, 220 by, for example, a communications bus. Each of the interface modules 210, 220 may be connected to a network interface. For example, user interface module 210 may be connected to UNI 130 via a communications bus.

The service lease handling module 225 may be configured to receive a message including data associated with a service lease time from a user device. For example, the service lease handling module 225 may receive a message from user 110 communicated through communication channel 125, UNI 130 and user interface module 210. The data associated with a service lease time may include a lease start time and a lease stop time. The data associated with a service lease time may also include, or alternatively include a lease type. The data may not be associated with a typical Ethernet data packet being communicated in the network. The lease type may include information indicating a periodicity for providing the service. The periodicity may be, for example, a duration for providing the service, a time of day for providing the service, a day the service is to be provided and the like.

The service lease handling module 225 may be configured to communicate the data associated with a service lease time to and from database 235. Database 235 may be configured to store the data associated with a service lease time. For example, database 235 may store, in association with an identifier of the users, the lease start time, the lease stop time, the lease type and/or information indicating a periodicity for providing the service.

The service lease handling module 225 may be configured to communicate with a timer module 230. The timer module 230 may determine when the service is to be transmitted and/or distributed to the user device based on the stored data associated with the service lease time. The timer module 230 may determine the lease start time and the lease stop time associated with the service based on stored data (e.g., timer data) associated with the service lease time. The stored data may be stored in a memory associated with the timer module 230 and/or in database 235

The service lease handling module 225 may also be configured to receive a service from a service provider. For example, the service lease handling module 225 may receive a service from a service provider associated with Metropolitan Area Network 155 communicated through communication channel 150, NNI 145 and E-MAN (S-VLAN) interface module 220. Service lease handling module 225 may not necessarily receive the service, but alternatively receive some indication that the service has been received by E-MAN (S-VLAN) interface module 220.

The service may be in the form of data-packets transmitted using a known protocol. For example, the service may be transmitted using at least one of the IEEE 802.1q and IEEE 802.1 ad standards. The IEEE 802.1q and IEEE 802.1ad standards are known by those skilled in the art and will not be further discussed for the sake of brevity.

The service lease handling module 225 may also be configured to transmit the service to the user based on the data associated with the service lease time. For example, the service lease handling module 225 may transmit or distribute the service to the user 110 through communication channel 125, UNI 130 and user interface module 210. Service lease handling module 225 may not necessarily transmit or distribute the service, but may alternatively signal some indication to the E-MAN (S-VLAN) interface module 220 to transmit or distribute the service to the user (e.g., user 110, user 115 or customer VLAN 120) via the user interface module 210.

In a static configuration of the Provider Edge Bridge 105 a service may flow from a service provider domain (e.g., Metropolitan Area Network 155) to a customer device/VLAN (e.g., users 110, 115 and Customer VLAN 120). Once the static configuration is established, service from service provider domain flows to the customer device/VLAN unless the configuration is removed from the Provider Edge Box.

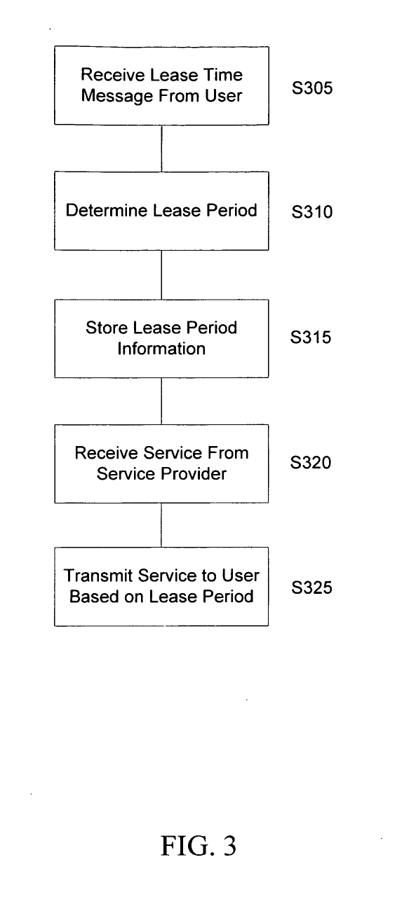

FIG. 3 illustrates a method for dynamic access of a service according to example embodiments. While describing the steps of the method associated with FIG. 3, reference will be made to the network of FIG. 1 and the service lease handling module 225 of FIG. 2.

In step S305 a lease time message is received from a user. For example, the service lease handling module 225 may receive a message from user 110 communicated through communication channel 125, UNI 130 and user interface module 210. The lease time message may be received via some messaging protocol, for example, any communication protocol, proprietary or standard, that can be used for communication between network devices may communicate the lease information. The lease time message may include a lease start time and a lease stop time. The lease time message may also include, or alternatively include a lease type. The lease type may include information indicating a periodicity for providing the service. The periodicity may be, for example, a duration for providing the service, a time of day for providing the service, a day the service is to be provided and the like.

In step S310 lease periods may be determined. Step S310 may be optional. For example, the lease time message may be in a format where the lease period is directly specified (e.g., a lease start time and a lease stop time). However, as described above, the lease time message may be in the form of a periodicity. As such, the service lease handling module 225 may determine one or more lease start times and lease stop times based on the periodicity.

In step S315 lease period information may be stored. For example, the service lease handling module 225 may communicate lease period information to database 235. Database 235 may store the data associated with a service lease time and associate the data with the user (e.g., user 110). For example, database 235 may store the lease start time, the lease stop time, the lease type and/or information indicating a periodicity for providing the service. The data may be stored in relation to some user identification. Alternatively or together with database 225, the service lease handling module 225 may store some or all of the lease period information, in relation to some user identification, in some memory associated with the service lease handling module 225. Step S315 may be optional. For example, the service lease handling module 225 may use the lease time message without storing any lease period information.

In step S320, a service is received from a service provider. A service is known by those skilled in the art and may include, for example, a video stream, an audio stream, an application, application data, a data packet, or the like. As described above, the service may be transmitted using a known protocol.

For example, in step S320, the service lease handling module 225 may receive the service from a service provider associated with Metropolitan Area Network 155 communicated through communication channel 150, NNI 145 and E-MAN (S-VLAN) interface module 220. Service lease handling module 225 may not necessarily receive the service, but alternatively receive some indication that the service has been received by E-MAN (S-VLAN) interface module 220.

In step S325, the service is transmitted to the user based on the lease period. For example, the service lease handling module 225 may transmit or distribute the service to user 110 communicated through communication channel 125, UNI 130 and user interface module 210. Service lease handling module 225 may not necessarily transmit or distribute the service, but alternatively signal some indication to the E-MAN (S-VLAN) interface module 220 to transmit or distribute the service to the user (e.g., user 110, user 115 or customer VLAN 120) via the user interface module 210.

For example, the service lease handling module 225 may transmit or distribute the service before the lease stop time or between the lease start time and lease stop time. Alternatively, the service lease handling module 225 may instruct one of the interface modules (e.g., user interface module 210 and/or E-MAN (S-VLAN module 220) to transmit or distribute the service before the lease stop time or between the lease start time and lease stop time. The service lease handling module 225 may not transmit the service before the lease start time and/or after the lease stop time.

Further, as described above, the service lease handling module 225 may communicate with timer module 230. In step S310, the timer module 230 may determine the lease period. In step S315, the timer module 230 may store the lease period information. In step S325, the timer module 230 may provide lease period information to the service lease handling module 225 such that the service lease handling module 225 may transmit the service to the user based on the lease period.

The following examples demonstrate the use of the aforementioned apparatus and method. The example is non-limiting and only intended to provide further description of the intended use.

For example, a user (e.g., user 110) may be on a computer situated in a Hotel Room. The requirement may be that service access should be given to the user only during the time that a guest is registered for the hotel room. The user may be staying as a guest of the hotel for three days. Therefore, the message may include information that the duration of enablement of the service is three days. The message may be communicated as part of an initial setup by the user or may be completed by, for example, a hotel clerk aiding the user (hotel guest) at check-in.

For example, a VLAN (e.g., VLAN 120) may be a LAN of some university. The requirement may be that service access is not required for some duration of day/night where the computing/bandwidth of the network are used for some computing purpose. Therefore, the message may include information that the service needs to be disabled from 9 p.m. to 6 a.m. every day. The message associated with the university may also have information associated with a duration (e.g., a duration of 3 months starting today). The message may be communicated by an administrator of the university LAN or by some other representative of the university who may responsible for the administration of services to the university. Both administrators may be acting as representatives of the end users of the university LAN.

While example embodiments have been particularly shown and described, it will be understood by one of ordinary skill in the art that variations in form and detail may be made therein without departing from the spirit and scope of the claims.

The invention being thus described, it will be obvious that the same may be varied in many ways. Such variations are not to be regarded as a departure from the invention, and all such modifications are intended to be included within the scope of the invention.

We claim:

1. A method for dynamic access of a service, the method comprising:
receiving, at a network device, a message including a lease time associated with the service from a user device;
receiving, by the network device, the service from a provider; and
transmitting the service, by the network device, to the user device based on the lease time.

2. The method of claim 1, further comprising:
determining, by the network device, a lease start time and a lease stop time based on the lease time; and
storing, by the network device, the lease start time and the lease stop time, wherein the transmitting the service is based on the lease start time and the lease stop time.

3. The method of claim 2, wherein the service is transmitted one of before the lease stop time and between the lease start time and lease stop time.

4. The method of claim 2, wherein the service is not transmitted at least one of before the lease start time and after the lease stop time.

5. The method of claim 1, wherein
the received message further includes a lease type, and
the lease type includes information indicating a periodicity for providing the service.

6. The method of claim 5, further comprising:
determining, by the network device, a timer based on the lease time and the lease type, wherein the transmitting the service is based on the timer.

7. The method of claim 6, wherein
the service is transmitted if the timer has not expired and the service is not transmitted if the timer has expired, and
an expired timer is reset after an elapsed time.

8. The method of claim 1, wherein the message is received at a metro edge switch.

9. A network device comprising:
a service lease handling module configured to receive a message including data associated with a service lease time from a user device, configured to receive a service from a service provider and configured to transmit the service to the user based on the data associated with the service lease time.

10. The network device of claim 9, further comprising:
a database configured to store the data associated with the service lease time;
a timer module configured to determine when the service is to be transmitted to the user device based on the stored data associated with the service lease time.

11. The network device of claim 10, wherein
the timer module determines a lease start time and a lease stop time associated with the service based on the stored data associated with the service lease time, and
the database stores the lease start time and the lease stop time.

12. The network device of claim 11, wherein the service lease handling module transmits the service one of before the lease start time and between the lease start time and lease stop time.

13. The network device of claim 11, wherein the service lease handling module does not transmit the service at least one of before the lease start time and after the lease stop time.

14. The network device of claim 10, wherein
the data associated with a service lease time includes a lease type, and
the lease type includes information indicating a periodicity for providing the service.

15. The network device of claim 10, further comprising:
a database configured to store the data associated with the service lease time;
a timer module configured to determine when the service is to be transmitted to the user device based on the stored data associated with the service lease time, wherein the service is transmitted to the user device during a first elapsed time and the service is not transmitted to the user during a second elapsed time.

16. The network device of claim 9, wherein the device is one of a provider edge bridge and a metro edge switch.
